(19) United States
(12) Patent Application Publication
(10) Pub. No.: US 2012/0271655 A1
(43) Pub. Date: Oct. 25, 2012

(54) Methods and Systems for Enabling Applications on a Mobile Computing Device to Access Data Associated with a Peripheral Medical Device

(76) Inventors: Yishai Knobel, Boston, MA (US); Inbal Latner, Boston, MA (US); Sonny Vu, Salem, NH (US); Omar Juma, Manchester, NH (US); Sridhar Iyengar, Salem, NH (US)

(21) Appl. No.: 13/446,135

(22) Filed: Apr. 13, 2012

Related U.S. Application Data
(60) Provisional application No. 61/477,082, filed on Apr. 19, 2011.

(51) Int. Cl. G06Q 50/24

(52) U.S. Cl. 705/3

(57) ABSTRACT

A method enables an application executing on a mobile computing device to access, via an application programming interface, data associated with a measurement taken by a blood glucose meter peripheral to the mobile computing device. The method includes transmitting, by a blood glucose meter peripherally connected to a mobile computing device, to a software module provided by a first organization and executing on the mobile computing device, a blood glucose reading of a user of the blood glucose meter. The method includes generating, by the software module, an identification of an event responsive to the transmitted blood glucose reading. The method includes providing, by the software module, an application programming interface allowing an application provided by a second organization and executing on the mobile computing device, to access data associated with at least one of the blood glucose reading and the identification of the event.

### BACKGROUND

The disclosure relates to enabling access to data associated with a medical device. More particularly, the methods and systems described herein relate to enabling applications on a mobile computing device to access data associated with a peripheral medical device.

In conventional systems for retrieving data from medical devices, a manufacturer of a medical device may provide software with which a user of the medical device may access data generated by the medical device from a personal computer. For example, conventional systems allow a user to interact with a manufacturer-provided application to download data from the medical device to the user's computer. However, conventional systems require that the manufacturer provide the application to the user. Typically, these systems do not provide other applications—those distributed by organizations unaffiliated with the medical device manufacturer—with access to that data. Therefore, a user of a medical device seeking to access personal health data generated by the medical device from a different application or to analyze or otherwise process the personal health data from a different application is unable to do so.

In some conventional systems, a manufacturer of a medical device provides other entities with access to medical device data via a web-based interface. However, reliance on a web-based interface typically results in numerous drawbacks. For example, a user of a personal computing device (including, for example, a smartphone) will typically require dependable Internet connectivity in order to access that data. Additionally, regularly connecting to the internet to retrieve data places a computational and power burden on the personal computing device—requiring, for example, an internet-enabled device with sufficient battery life to maintain that connection. Given the critical nature of medical device data, and especially in contexts where emergency medial services may be provided based on medical device data, unreliable access to medical device data may be unacceptable to a user or the manufacture and may in fact be detrimental to the user's health or even fatal. Furthermore, given the sensitive nature of personal health data, introducing a third party (such as the organization that provides the web-based computing), introduces additional regulatory requirements due to various consumer data privacy laws.

### BRIEF SUMMARY

In one aspect, methods and systems described herein provide functionality enabling an application executing on a mobile computing device to access data associated with a measurement taken by a medical device connected peripherally to the mobile computing device, via an application programming interface (API). In one embodiment, the medical device and the mobile computing device are physically proximate to each other, and the application executing on the mobile computing device accesses the data locally. In these embodiments, the application can access medical device data without use of a web-based API. Because the application can access the data locally, the user of the mobile computing device need not rely on remotely located data—or remotely located applications—to receive medical services. The mobile computing device may provide this functionality to the user regardless of Internet connectivity. The mobile computing device may provide this functionality without requiring the additional power consumption required in embodiments in which additional Internet connectivity requires additional battery power. In additional embodiments, the mobile computing device includes functionality for charging a battery of the medical device. In other embodiments, the medical device includes functionality for charging a battery of the mobile computing device. Furthermore, in embodiments in which the user of the mobile computing device may require emergency medical services—for example, having a doctor contact them if personal health data indicates a level of risk to the user's health—having access to that data, and to the ability to make that call locally, provides enhanced functionality for the user.

In one aspect, a system for enabling an application executing on a mobile computing device to access, via an application programming interface, data associated with a measurement taken by a medical device peripheral to the mobile computing device, includes a medical device peripherally connected to a mobile computing device, a software module provided by a first organization and an application provided by a second organization. In another aspect, a system for enabling an application executing on a mobile computing device to access, via an application programming interface, data associated with a measurement taken by a blood glucose meter peripheral to the mobile computing device, includes a blood glucose meter peripherally connected to a mobile computing device, a software module provided by a first organization and an application provided by a second organization.

In another aspect, a method enables an application executing on a mobile computing device to access, via an application programming interface, data associated with a measurement taken by a blood glucose meter peripheral to the mobile computing device. The method includes transmitting, by a blood glucose meter peripherally connected to a mobile computing device, to a software module provided by a first organization and executing on the mobile computing device, a blood glucose reading of a user of the blood glucose meter. The method includes generating, by the software module, an identification of an event responsive to the transmitted blood glucose reading. The method includes providing, by the software module, an application programming interface allowing an application provided by a second organization and executing on the mobile computing device, to access data associated with at least one of the blood glucose reading and the identification of the event.

In one embodiment, the method includes displaying, by the application, a message on the mobile computing device, responsive to accessing the data associated with at least one of the blood glucose reading and the identification of the event. In another embodiment, the method includes transmitting the data associated with at least one of the blood glucose reading and the identification of the event, by the application executing on the mobile computing device, to at least one of the second organization and a third organization. In still another embodiment, the method includes transmitting, by the software module, to the application, a result of an analysis of a data set including the transmitted blood glucose reading.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a mobile computing device peripherally connected to a medical device;

FIGS. 1B-1C are block diagrams depicting embodiments of computers useful in connection with the methods and systems described herein;

FIG. 2 is a block diagram depicting an embodiment of a mobile computing device peripherally connected to a blood glucose meter;

FIG. 3A is a flow diagram depicting an embodiment of a method for enabling an application executing on a mobile computing device to access, via an application programming interface, data associated with a measurement taken by a blood glucose meter peripheral to the mobile computing device;

FIG. 3B is a block diagram depicting an embodiment of a networked environment useful in connection with the methods and system described herein;

FIG. 3C is a flow diagram depicting an embodiment of a method enabling an application executing on a mobile computing device to access personal data associated with a measurement taken by a medical device peripherally connected to the mobile computing device;

FIG. 4 is a screen shot depicting an embodiment in which a first organization provides a customized application to a second organization;

FIG. 5 is a screen shot depicting an embodiment in which a first organization generates a first application that a second organization incorporates into a non-clinical application; and

FIG. 6 is a screen shot depicting an embodiment in which a second organization provides a clinical application that incorporates data retrieved via the application programming interface 109 provided by a first organization.

### DETAILED DESCRIPTION

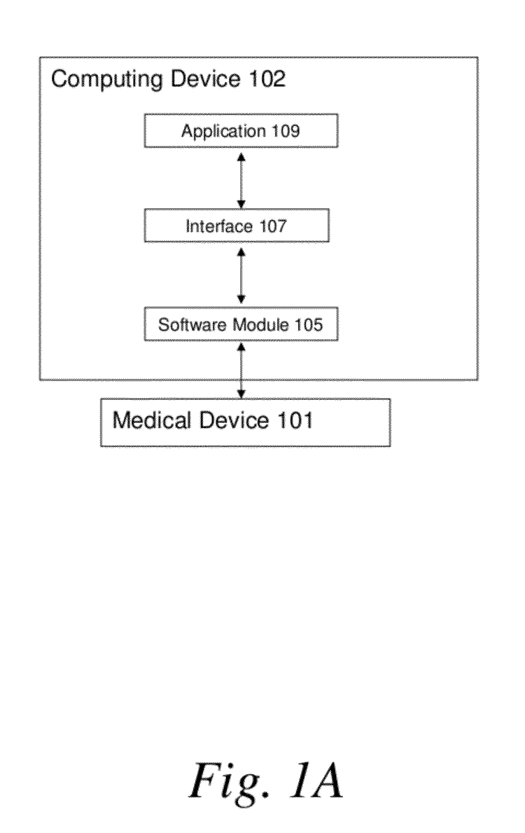

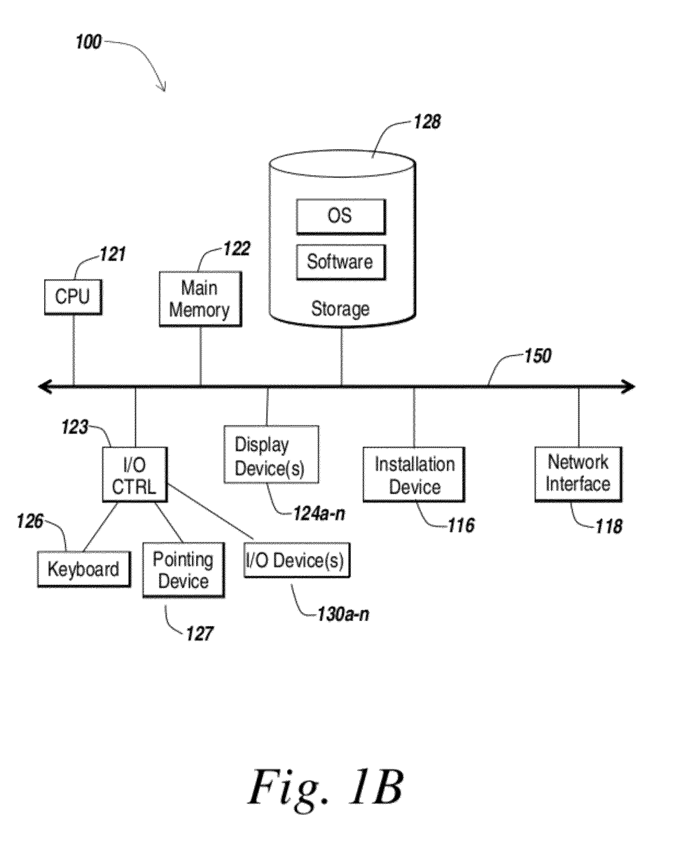

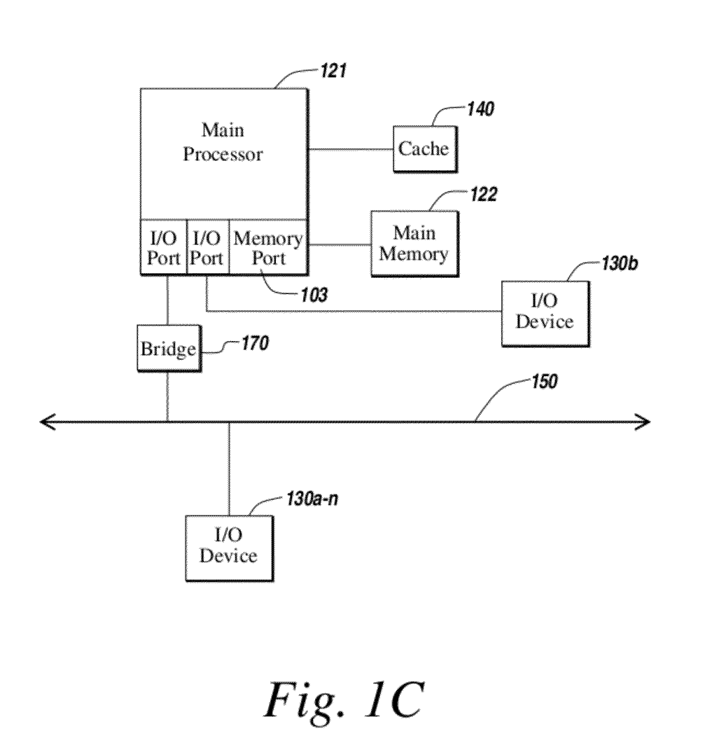

Referring now to FIG. 1A, an embodiment of a system enabling applications on a mobile computing device to access data associated with a peripheral medical device is depicted. The system includes a computing device 102, and a medical device 101, an application 109, a software module 105, and an interface 107. In some embodiments, the computing device 102 is a mobile computing device.

In one embodiment, the medical device 101 is a device that receives personal health data from a user. In another embodiment, the medical device 101 is a blood glucose meter. In still another embodiment, the medical device 101 is an insulin pump system. In some embodiments, the medical device 101 includes a computing device; for example, an insulin pump may include or be provided on a computing device 102. In other embodiments, the medical device 101 is a device such as, without limitation, those manufactured by Tandem Diabetes Care, Inc., of San Diego, Calif.; by Animas Corporation, a Johnson & Johnson Company, of West Chester, Pa.; by Medtronic MiniMed, Inc., of Northridge, Calif.; or by AgaMatrix, Inc., of Salem, N.H.

In one embodiment, the medical device 101 is a pedometer; for example, the medial device 101 may be a device such as those provided by Fitbit, Inc., of San Francisco, Calif. In another embodiment, the medical device 101 is a digital scale; for example, the medial device 101 may be a device such as those provided by WiThings, Inc., of Lewes, Del. In still another embodiment, the medical device 101 is a blood pressure cuff; for example, the medial device 101 may be a device such as those provided by iHealth Labs, Inc., of Mountain View, Calif.

The medical device 101 is peripherally connected to the computing device 102. In one embodiment, the medical device 101 is physically connected to the computing device 102; for example, the medical device 101 and the computing device 102 may be connected via a Universal Serial Bus (USB) connector. In another embodiment, the medical device 101 and the computing device 102 may be connected via a wireless communications protocol; for example, a WiFi connection, a Bluetooth connection, a connection established according to the ZigBee specification, or other wireless connection may connect the medical device 101 and the computing device 102.

The computing device 102 and/or the mobile device 101 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the computing device 102 and mobile device 101. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, and a pointing device 127, such as a mouse. The storage device 128 may include, without limitation, an operating system, and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 communicates directly with I/O device 130b via HYPERTRANSPORT, RAPIDIO, or INFINIBAND communications technology. FIG. 1C also depicts an embodiment in which local buses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs. The computing device 100 may further comprise a storage device, such as one or more hard disk drives or redundant arrays of independent disks, for storing an operating system and other software. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to the network 104 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. One ordinarily skilled in the art will recognize and appreciate the various embodiments in which a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7 and WINDOWS VISTA, all of which are manufactured by Microsoft Corporation of Redmond, Wash.; MAC OS, manufactured by Apple Inc., of Cupertino, Calif.; OS/2, manufactured by International Business Machines of Armonk, N.Y.; and any type and/or form of a Unix operating system.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments the computing device 100 is a mobile device, such as a JAVA-enabled cellular telephone or personal digital assistant (PDA). The computing device 100 may be a mobile device such as those manufactured, by way of example and without limitation, by Motorola Corp. of Schaumburg, Ill.; Kyocera of Kyoto, Japan; Samsung Electronics Co., Ltd., of Seoul, Korea; Nokia of Finland; Hewlett-Packard Development Company, L.P. and/or Palm, Inc., of Sunnyvale, Calif., USA; Sony Ericsson Mobile Communications AB of Lund, Sweden; or Research In Motion Limited, of Waterloo, Ontario, Canada. In yet other embodiments, the computing device 100 is a smart phone, Pocket PC, Pocket PC Phone, or other portable mobile device supporting Microsoft Windows Mobile Software.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Inc., of Cupertino, Calif. In another of these embodiments, the digital audio player may function as both a portable media player and as a mass storage device. In other embodiments, the computing device 100 is a digital audio player such as those manufactured by, for example, and without limitation, Samsung Electronics America, of Ridgefield Park, N.J., Motorola Inc. of Schaumburg, Ill., or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a device in the Motorola line of combination digital audio players and mobile phones. In another of these embodiments, the computing device 100 is device in the iPhone smartphone line of devices, manufactured by Apple Inc., of Cupertino, Calif. In still another of these embodiments, the computing device 100 is a device executing the Android open source mobile phone platform distributed by the Open Handset Alliance; for example, the device 100 may be a device such as those provided by Samsung Electronics of Seoul, Korea, or HTC Headquarters of Taiwan, R.O.C.

Referring again to FIG. 1A, the system includes a software module 105. In one embodiment, the software module 105 is provided by a first organization. In another embodiment, the software module 105 is an application program executing on the computing device 102. In still another embodiment, the software module 105 includes a user interface. In yet another embodiment, the software module 105 does not include a user interface; for example, the software module 105 may be a background process that executes without user interaction.

In some embodiments, the software module 105 includes a receiver in communication with the medical device 101. In one of these embodiments, the receiver receives personal health data from the medical device 101. For example, the medical device 101 may transmit personal health data associated with a user of the medical device 101 to the receiver. In other embodiments, the software module 105 may include sub-modules (not shown) that execute to provide the functionality of the software module 105. In one of these embodiments, the software module 105 includes an analysis module that performs at least one type of analysis on data accessed by the software module 105, including but not limited to personal health data received from the medical device 101. In another of these embodiments, the software module 105 includes a module generating user interfaces for display on the computing device 102. In still another of these embodiments, the software module 105 further comprises a storage module for storing data received from the medical device 101. In yet another of these embodiments, the software module 105 further comprises a storage module for storing data received from an application 109.

The system includes an application 109. In one embodiment, the software module 105 and the application 109 are provided by different organizations. In another embodiment, the software module 105 and the application 109 are provided by a single organization. In still another embodiment, the software module 105 is embedded within the application 109. In yet another embodiment, the application 109 is a user-facing application. In some embodiments, at least one application 109 is provided by each of a plurality of organizations. In one of these embodiments, each of the applications 109 provided by each of the plurality of organizations use the same interface 107 to access data from the software module 105.

The system includes an interface 107. In one embodiment, the interface 107 is an application programming interface. In another embodiment, the interface 107 is in communication with the software module 105. In one embodiment, the same organization provides the software module 105 and the interface 107. In another embodiment, the interface 107 is provided separately from the software module 105. In another embodiment, the interface 107 is an application programming interface through which the application 109 interacts with data the software module 105 receives from the medical device 101.

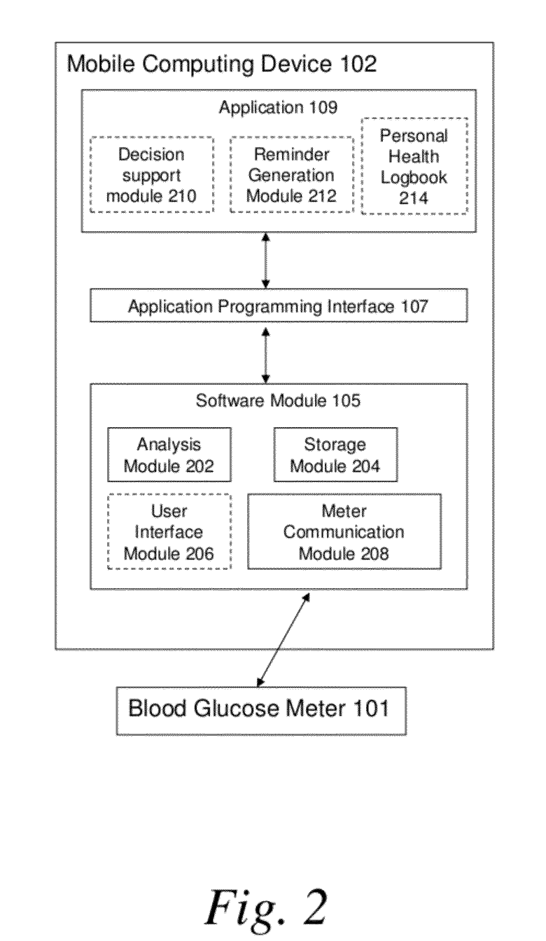

Referring now to FIG. 2, a block diagram depicts an embodiment of a system for enabling an application executing on a mobile computing device to access, via an application programming interface, data associated with a measurement taken by a blood glucose meter peripheral to the mobile computing device. In brief overview, the system includes a blood glucose meter 101, a mobile computing device 102, a software module 105, an application programming interface 107, an application 109, an analysis module 202, a storage module 204, and a meter communication module 208. In some embodiments, the software module 105 includes a user interface module 206 (shown in shadow in FIG. 2).

Referring now to FIG. 2, and in greater detail, the blood glucose meter 101 is peripherally connected to the mobile computing device 102. In one embodiment, the blood glucose meter 101 is a medical device as described above in connection with FIGS. 1A-1C. In some embodiments, and as one of ordinary skill in the art will understand, blood glucose meters are medical devices used by patients suffering from Type 1 or Type 2 diabetes to monitor a level of blood glucose in their blood.

In one embodiment, the software module 105 is a module as described above in connection with FIG. 1A. The software module 105 is provided by a first organization and executes on the mobile computing device 102, which may be provided as a computing device 100 described above in connection with FIGS. 1A-1C. The software module 105 receives, from the blood glucose meter 101, a blood glucose reading. The software module 105 generates an identification of an event responsive to the received blood glucose reading.

In one embodiment, the software module 105 includes an analysis module 202 analyzing data including the transmitted blood glucose reading. In another embodiment, the software module 105 includes a storage module 204 storing the transmitted blood glucose reading on the mobile computing device. In some embodiments, the storage module 204 transmits the blood glucose reading to a second computer 102b for storage. In still another embodiment, the software module 105 includes a user interface module 206, which generates a user interface for display by the application 109 to a user of the mobile computing device 102. In some embodiments, the software module 105 includes a meter communication module 208 in communication with the blood glucose meter 101. In one of these embodiments, the meter communication module 208 may, for example, receive a blood glucose reading from the blood glucose meter 101. In another of these embodiments, the meter communication module 208 may be in communication with the analysis module 202; for example, the meter communication module 208 may send the received blood glucose reading to the analysis module 202. In other embodiments, the software module 105 is embedded within the application 109 provided by the second organization.

The system includes an application programming interface 107. In some embodiments, the application programming interface 107 is an interface as described above in connection with FIGS. 1A-1C. In one embodiment, the organization that provides the software module 105 provides the application programming interface 107. In another embodiment, the software module 105 includes a description of the application programming interface 107. In some embodiments, the application programming interface 107 provides access to data generated by, retrieved by, or stored on a sub-module in the software module 105 (e.g., the analysis module 202, the storage module 204, and the meter communication module 208).

In one embodiment, the application programming interface 107 exposes glucose reading data, as well as several associated data types: mealtime tags (before/after lunch, before/after dinner), insulin values, carbohydrate values, notes related to a specific blood glucose reading that might have had an impact on the measurement, such as: food or alcohol intake, amount of exercise, unique insulin attributes, change in dose amount or schedule, sick day, and more, as well as data and time of the measurement. In another embodiment, the application programming interface 107 exposes any additional data that will be added to a particular date and time stamp that also correlates to a blood glucose reading, such as blood pressure or weight.

In some embodiments, the application programming interface 107 provides functionality allowing the application 109 to access data from the software module 105.

The application 109 is provided by a second organization and executes on the mobile computing device 102. The application 109 accesses, via the application programming interface 107, data associated with at least one of the blood glucose reading and the identification of the event. In one embodiment, the application 109 includes a reminder generation module 212 (depicted in shadow in FIG. 2). In another embodiment, the application 109 includes a medical decision support module 210 (depicted in shadow in FIG. 2). In still another embodiment, the application 109 includes a personal health logbook 214 (depicted in shadow in FIG. 2). It should be understood that in various embodiments, the application 109 might include some, none, or multiples of each of these optional modules.

In one embodiment, a first organization provides the software module 105 and the application programming interface 107 while a second organization provides the application 109. For example, a manufacturer of the blood glucose meter 101 may provide the software module 105 to a user of the blood glucose meter 101 for installation on a mobile computing device 102 accessed by the user. By implementing the methods and systems described herein, a second organization may now provide the user of the mobile computing device 102 with an application 109 enhanced by the ability to incorporate into its functionality access to data generated by the blood glucose meter 101 and/or the software module 105.

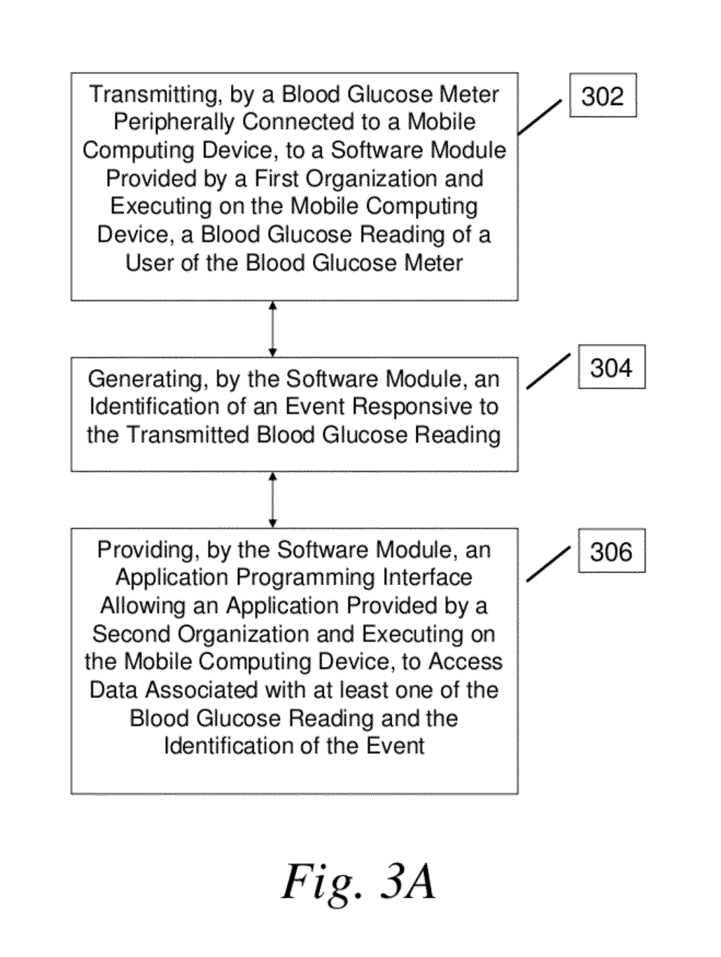

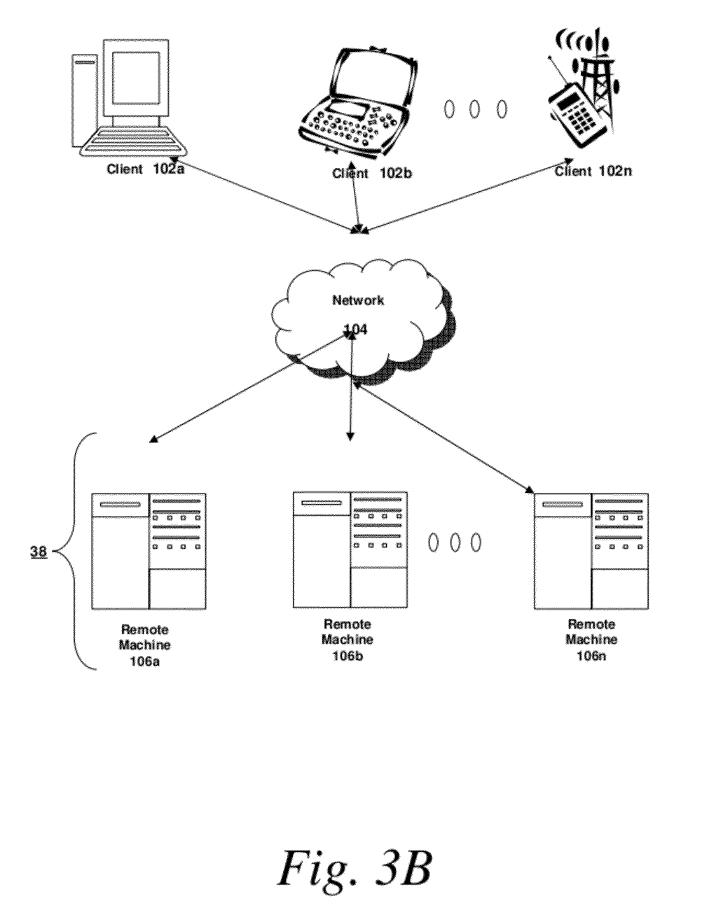

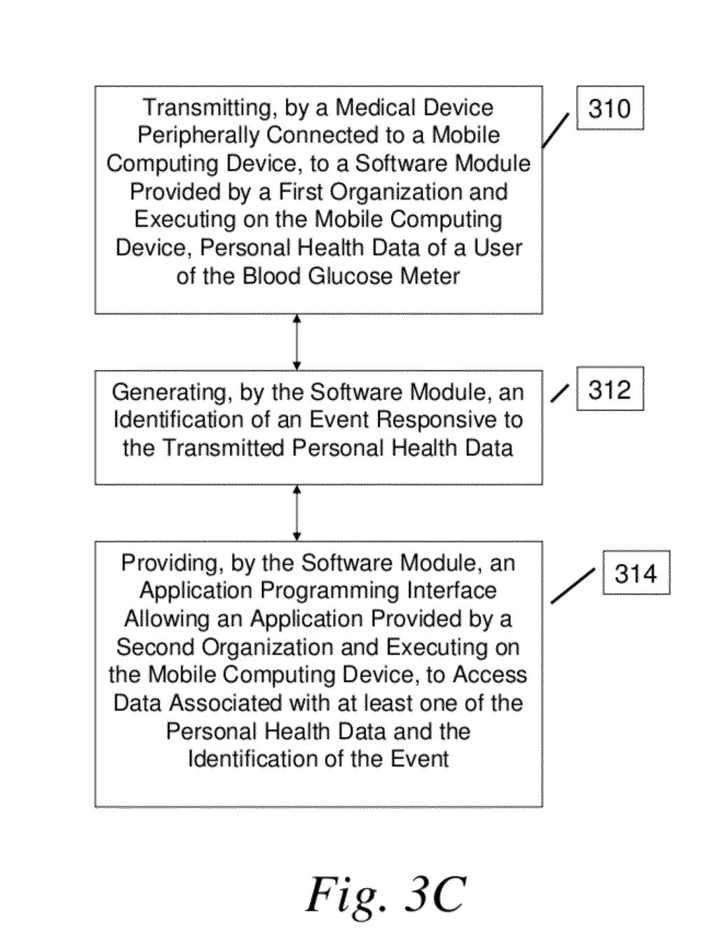

Referring now to FIG. 3A, a flow diagram depicts one embodiment of a method for enabling an application executing on a mobile computing device to access, via an application programming interface, data associated with a measurement taken by a blood glucose meter peripheral to the mobile computing device. In brief overview, the method includes transmitting, by a blood glucose meter peripherally connected to a mobile computing device, to a software module provided by a first organization and executing on the mobile computing device, a blood glucose reading of a user of the blood glucose meter (302). The method includes generating, by the software module, an identification of an event responsive to the transmitted blood glucose reading (304). The method includes providing, by the software module, an application programming interface allowing an application provided by a second organization and executing on the mobile computing device, to access data associated with at least one of the blood glucose reading and the identification of the event (306).

Referring still to FIG. 3A, and in greater detail, the method includes transmitting, by a blood glucose meter peripherally connected to a mobile computing device, to a software module provided by a first organization and executing on the mobile computing device, a blood glucose reading of a user of the blood glucose meter (302). In some embodiments, the software module 105 receives a plurality of blood glucose readings for a single user of the blood glucose meter 101. In other embodiments, the software module 105 receives at least one blood glucose reading for each of a plurality of users of the blood glucose meter 101.

In one embodiment, the software module 105 receives, from the blood glucose meter 101, data associated with the blood glucose meter. In another embodiment, the software module 105 receives data including an identification of a power status of the blood glucose meter 101 (e.g., on, off, re-booting, in a power-saving mode). In still another embodiment, the software module 105 may receive data including an identification of a maintenance level of the blood glucose meter 101 (e.g., batteries low, charging required, data synchronization required, data synchronization in progress, data synchronization up-to-date). In still another embodiment, the software module 105 receives data associated with a test strip used in conjunction with the blood glucose meter; for example, the software module 105 may receive data indicating that a user has attempted to use an incorrect type of test strip, invalidating a reading, or that a user has placed a control solution on the strip (instead of blood) for testing purposes. As another example, the software module 105 may receive data indicating (e.g., via a serial number or other identifier) that a user has taken a reading with a final test strip in a plurality of test strips; as will be described in further detail below, the software module 105 may conclude from such data that the user should be reminded to purchase additional test strips. In some embodiments, the software module 105 retrieves from the blood glucose meter 101, by way of example and without limitation, a name of a distributor of the blood glucose meter 101, identification or configuration data of the blood glucose meter 101 for diagnostic purposes (e.g., model, product name, serial number), and additional information the blood glucose meter 101 stores, such as units used (mg/dL or mmol/l).

The method includes generating, by the software module, an identification of an event responsive to the transmitted blood glucose reading (304). In one embodiment, the software module 105 performs an analysis on data including the transmitted blood glucose reading. In another embodiment, the analysis module 202 performs an analysis on data including the transmitted blood glucose reading.

In one embodiment, the software module 105 generates an identification of an event indicating that a user of the blood glucose meter 101 has taken a reading of his or her blood glucose level. In some embodiments, the software module 105 determines a number of blood glucose readings that have been generated by the blood glucose meter 101 for a user, responsive to receiving one or more blood glucose readings from the blood glucose meter 101. In one of these embodiments, the software module 105 generates an identification of an event indicating that the user has taken a number of blood glucose readings that is less than a recommended number of readings during a specified period of time. In another of these embodiments, the software module 105 generates an identification of an event indicating that a user should purchase additional test strips for use with the blood glucose meter 101; for example, the software module 105 may access data identifying a number of test strips previously purchased by the user and compare the number of test strips with the number of blood glucose readings to determine that the user has run out or will soon run out of test strips.

In other embodiments, the software module 105 receives data from the blood glucose meter 101 specifying a blood glucose level of a user of the blood glucose meter 101 (e.g., the received blood glucose reading). In one of these embodiments, the software module generates an identification of an event indicating that the user has a high blood glucose level, responsive to the received data. In another of these embodiments, the software module generates an identification of an event indicating that the user has a low blood glucose level, responsive to the received data. In another of these embodiments, the software module generates an identification of an event indicating that the user has an acceptable blood glucose level, responsive to the received data.

In one embodiment, the software module 105 performs a statistical analysis of a plurality of blood glucose readings received from the blood glucose meter 101. In another embodiment, the software module 105 generates an average blood glucose level over a period of time for a user of the blood glucose meter 101, based upon a plurality of blood glucose readings received from the blood glucose meter 101. In some embodiments, by way of example, the software module 105 performs statistical analyses including, without limitation, correlations between a blood glucose reading and, for example, a level of carbohydrate intake, insulin values or amounts of exercise.

In one embodiment, the software module 105 performs a pattern analysis of a plurality of blood glucose readings received from the blood glucose meter 101. In another embodiment, by way of example, the software module 105 may identify a pattern between blood glucose levels and data associated with a meal, e.g., glucose levels for a specific date range, before and after lunch.

In some embodiments, the software module 105 identifies a pattern in a user's blood glucose readings. In one of these embodiments, the software module 105 identifies a time of day during which the user is likely to have a high blood glucose level. In another of these embodiments, the software module 105 identifies a time of day during which the user is likely to have a low blood glucose level. In still another of these embodiments, the software module 105 identifies a time of day during which the user is likely to consume food resulting in an adverse affect on a blood glucose level of the user. In yet another of these embodiments, the software module 105 identifies a time of day during which the user should be reminded to consume food to prevent an adverse affect on a blood glucose level of the user. In other embodiments, the software module 105 identifies a pattern of blood glucose readings behavior on a certain day of the week or certain meals, e.g. a particularly high blood glucose measure (or average) on Sundays or post-lunch.

In one embodiment, the software module 105 transmits the blood glucose reading to the application 109; for example, upon receiving a request from the application 109 via the interface 107, the software module 105 may transmit the reading. In another embodiment, the software module 105 transmits data associated with the blood glucose reading to the application 109. In still another embodiment, the software module 105 transmits a result of an analysis of a data set including the transmitted blood glucose reading to the application 109.

The method includes providing, by the software module, an application programming interface allowing an application provided by a second organization and executing on the mobile computing device, to access data associated with at least one of the blood glucose reading and the identification of the event (306). In one embodiment, the first organization provides the application programming interface 107.

In one embodiment, the application 109 accesses the data associated with at least one of the blood glucose reading and the identification of the event; for example, the application 109 may use the application programming interface 107 to access the blood glucose reading, the identification of the event, and/or any data generated by the software module 105 as a result of an analysis of the blood glucose reading.

In some embodiments, the storage module 204 of the software module 105 stores readings with associated data; this metadata may include, by way of example, date, time, mealtime tags, and glucose levels. In one of these embodiments, the application programming interface 107 allows the application 109 to use the associated data in a query to the software module 105 for specific blood glucose readings. For example, the application programming interface 107 may allow the application 109 to search by date, time, mealtime tags, etc., and receive back specific blood glucose readings associated with that data.

In some embodiments, the application 109 provides functionality for maintaining a personal health logbook. In one of these embodiments, a user may annotate data retrieved via the application programming interface 107; for example, a user may make a note about what he or she ate at a time when the application 109 generates an exercise reminder or a recalculation of an insulin dosage level. In another of these embodiments, the user may keep a food log, exercise log, or other record of data impacting his or her personal health data.

In some embodiments, the application 109 includes a medical decision support module 210 generating decision support data, based upon the data accessed via the application programming interface 107. In one of these embodiments, the decision support module 210 generates decision support data for a user of the blood glucose meter 101. For example, where the user suffers from diabetes, the decision support module 210 may access data generated by the software module 105 and generate data that supports the user in managing diabetes, such as, by way of example, a revised insulin dosage calculation. In another of these embodiments, the decision support module 210 generates decision support data for a caregiver. For example, where the user of the application 109 is a parent or physician caring for the user of the blood glucose meter 101, the decision support module 210 may generate data that supports the caregiver in making decisions such as, without limitation, recommendations for changes to a diet of the user of the blood glucose meter 101 (indicating to a parent that the child should eat more or less of certain types of food) or disease management recommendations for a doctor treating the user of the blood glucose meter 101.

In other embodiments, the application 109 includes a reminder generation module 212. In one of these embodiments, the reminder generation module 212 generates a reminder for display to a user of the mobile computing device 102 in response to data accessed via the application programming interface 107. In another of these embodiments, the reminder generation module 212 generates a reminder that the user should eat more of a particular type of food. In still another of these embodiments, the reminder generation module 212 generates a reminder that the user should eat less of a particular type of food. In yet another of these embodiments, the reminder generation module 212 generates a reminder that the user should exercise.

In another of these embodiments, the reminder generation module 212 generates a reminder that the user should adjust a dosage of medication (e.g., provide insulin titration advice). In still another of these embodiments, the reminder generation module 212 generates a reminder that the user should test their blood glucose level. In yet another of these embodiments, the reminder generation module 212 generates a reminder providing positive feedback to the user, based upon trends or other data accessed via the application programming interface 107.

In some embodiments, the application 109 includes calendaring functionality. In one of these embodiments, the reminder generation module 212 includes calendaring functionality. In other embodiments, the application 109 is in communication with a separate calendar application (not shown), which may execute either on the mobile computing device 102 or on a second computing device 102.

In some embodiments, the application 109 allows, via calendaring functionality, a user to add scheduled appointments (e.g., appointments with doctors, health professionals, lab tests, etc.). In one of these embodiments, the reminder generation module 212 generates a reminder for an appointment stored by the calendaring functionality. In other embodiments, the reminder generation module 212 is in communication with an external calendar and generates reminders based upon data stored in the external calendar.

In some embodiments, the application 109 maintains an identification of a level of appointment completion. In one of these embodiments, the application 109 determines that a user attended, or failed to attend, a scheduled appointment. In another of these embodiments, the application 109 generates an identification of appointment completion based upon a determination that the user attended, or failed to attend, the scheduled appointment.

In one embodiment, the application 109 displays a message on the mobile computing device 102, responsive to accessing the data associated with at least one of the blood glucose reading and the identification of the event. In another embodiment, the application 109 displays a message generated by the decision support module 210. In still another embodiment, the application 109 displays a message generated by the reminder generation module 212.

In one embodiment, the application 109 displays a driving safety notification. In another embodiment, the application 109 displays a supply and ordering notification. In still another embodiment, the application 109 suggests an action to be taken by the user for preventative care. In still even another embodiment, the application 109 displays a decision support notification for a patient. In yet another embodiment, the application 109 displays a decision support notification for a caregiver. In a further embodiment, the application 109 displays a reward or incentive system notification.

In some embodiments, the application 109 accesses a user interface element generated by the user interface module 206. In one of these embodiments, the user interface module 206 generates a chart, graphic, photograph, video, or other multimedia element for use by the application in an interface displayed to a user of the mobile computing device 102. In other embodiments, however, the application 109 generates a user interface element for display to a user of the mobile computing device 102; for example, the application 109 may generate a multimedia element for display based upon data accessed via the application programming interface 107.

In some embodiments, the application 109 includes a communications module (not shown) that exchanges data with at least one remote machine. In other embodiments, the application 109 directs the exchange of data by communications functionality provided on the mobile computing device 102.

In one embodiment, the application 109 transmits the data associated with at least one of the blood glucose reading and the identification of the event to the second organization. In another embodiment, the application 109 transmits the data associated with at least one of the blood glucose reading and the identification of the event to a third organization.

Referring now to FIG. 3B, a block diagram depicts one embodiment of a networked environment in which the mobile computing device 102 may transmit data to at least one remote machine 106, such as one or more machines operated by any or all of the first organization, the second organization, and the third organization. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106, or remote machine(s) 106) via one or more networks 104. The clients 102 and the remote machines 106 may be provided as or executing on computing devices 100 as described above in connection with FIGS. 1A-1C.

Although FIG. 3B shows a network 104 between the clients 102 and the remote machines 106, the clients 102 and the remote machines 106 may be on the same network 104. The network 104 can be a local-area network (LAN), such as a company Intranet, a metropolitan area network (MAN), a wide area network (WAN), such as the Internet or the World Wide Web, or a wireless personal area network (WPAN). In some embodiments, there are multiple networks 104 between the clients 102 and the remote machines 106. In one of these embodiments, a network 104b (not shown) may be a private network and a network 104a may be a public network. In another of these embodiments, a network 104a may be a private network and a network 104b a public network. In still another embodiment, networks 104a and 104b may both be private networks. In still another embodiment, networks 104a and 104b may both be public networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

In some embodiments, the system may include multiple, logically-grouped remote machines 106. In one of these embodiments, the logical group of remote machines may be referred to as a server farm 38. In another of these embodiments, the remote machines 106 may be geographically dispersed. In other embodiments, a server farm 38 may be administered as a single entity. In still other embodiments, the server farm 38 comprises a plurality of server farms 38. The remote machines 106 within each server farm 38 can be heterogeneous—one or more of the remote machines 106 can operate according to one type of operating system platform (e.g., WINDOWS NT, WINDOWS 2003, WINDOWS 2008, manufactured by Microsoft Corp. of Redmond, Wash.), while one or more of the other remote machines 106 can operate on according to another type of operating system platform (e.g., Unix or Linux).

The remote machines 106 of each server farm 38 do not need to be physically proximate to another remote machine 106 in the same server farm 38. Thus, the group of remote machines 106 logically grouped as a server farm 38 may be interconnected using a wide-area network (WAN) connection or a metropolitan-area network (MAN) connection. For example, a server farm 38 may include remote machines 106 physically located in different continents or different regions of a continent, country, state, city, campus, or room.

A remote machine 106 may be a file server, application server, web server, proxy server, appliance, network appliance, gateway, application gateway, gateway server, virtualization server, deployment server, SSL VPN server, or firewall. In some embodiments, a remote machine 106 provides a remote authentication dial-in user service, and is referred to as a RADIUS server. In some embodiments, the web server 106 comprises an open-source web server, such as the APACHE servers maintained by the Apache Software Foundation of Delaware. In other embodiments, the web server executes proprietary software, such as the Internet Information Services products provided by Microsoft Corporation of Redmond, Wash., the SUN JAVA web server products provided by Sun Microsystems, of Santa Clara, Calif., or the BEA WEBLOGIC products provided by BEA Systems, of Santa Clara, Calif.

In one embodiment, an IT infrastructure may extend from a first network—such as a network owned and managed by an enterprise—into a second network, which may be owned or managed by a separate entity than the entity owning or managing the first network. Resources provided by the second network may be said to be “in a cloud.” Cloud-resident elements may include, without limitation, storage devices, servers, databases, computing environments (including virtual machines and desktops), and applications. In other embodiments, one or more networks providing computing infrastructure on behalf of customers is referred to a cloud. In one of these embodiments, a system in which users of a first network access at least a second network including a pool of abstracted, scalable, and managed computing resources capable of hosting user resources may be referred to as a cloud computing environment. In another of these embodiments, resources may include, without limitation, virtualization technology, data center resources, applications, and management tools. In some embodiments, Internet-based applications (which may be provided via a “software-as-a-service” model) may be referred to as cloud-based resources. In other embodiments, networks that provide users with computing resources, such as virtual machines or blades on blade servers, may be referred to as compute clouds. In still other embodiments, networks that provide storage resources, such as storage area networks, may be referred to as storage clouds. In further embodiments, a resource may be cached in a local network and stored in a cloud.

In some embodiments, the application 109 transmits data to the second organization, which provided the user of the mobile computing device 102 with the application 109. In other embodiments, the application 109 transmits data to a third organization, unaffiliated with either the organization that provided the software module 105 or the organization that provided the application 109. The application 109 may transmit data to organizations including, by way of example and without limitation, hospitals, doctors' offices, health care institutions, insurance companies (e.g., for processing an insurance claim related to the data, such as an order for additional medical supplies, or for processing a claim for a health incentive, such as a rebate provided to users who maintain a blood glucose level within a specified range), caregivers (e.g., a mobile device 102b of a parent of the user of the mobile computing device 102a), pharmacies (e.g., transmitting a request for acquisition of medical supplies on behalf of the user of the mobile computing device 102), electronic medical records systems (e.g., for automatic entering of personal health data into an EMR associated with the user), and an emergency medical service (e.g., placing a 911 call in the event that the application 109 determines that the user of the mobile computing device 102 is in need of emergency care).

In other embodiments, the organization receiving data from the application 109 may not be a health care organization. In one of these embodiments, by way of example, the application 109 transmits data to a social network, e.g., for exchanging data with a community of peers managing a similar disease as the user. In another of these embodiments, the application 109 transmits data to a food service establishment; for example, the user may check in to a restaurant that provides incentives to customers who purchase healthy foods. In still another of these embodiments, the application 109 may transmit data to a computing device 100 operated by a gaming organization. In this embodiment, and by way of example, an organization may operate a game that rewards points to users based on how well the monitor their disease, allowing them to purchase physical or virtual goods or services using these points. In another example, organizations providing mobile coupons or location-based services allow users to exchange points received for monitoring their disease for offers and promotions based on location or lifestyle preferences.

As indicated above in connection with FIG. 1A, the medical device 101 may be any of a number of different types of devices. Although the method depicted in FIG. 3A is described in the context of a blood glucose meter, it should be understood that the medical device need not be a blood glucose meter. As shown in FIG. 3C, the methods described herein also enable an application executing on a mobile computing device to access personal data associated with a measurement taken by a medical device of any kind peripherally connected to the mobile computing device. FIG. 3C depicts a flow diagram for one embodiment of a method including transmitting, by a medical device peripherally connected to a mobile computing device, to a software module provided by a first organization and executing on the mobile computing device, personal health data of a user of the medical device (310). The method includes generating, by the software module, an identification of an event responsive to the transmitted personal health data (312). The method includes providing, by the software module, an application programming interface allowing an application provided by a second organization and executing on the mobile computing device, to access data associated with at least one of the personal health data and the identification of the event (314).

A medical device 101 peripherally connected to a mobile computing device 102 transmits, to a software module 105 provided by a first organization and executing on the mobile computing device 102, personal health data of a user of the medical device 101 (310). In one embodiment, the medical device 101 transmits the personal health data to the software module 105 as described above in connection with FIGS. 1A-3B. The personal health data may include not just blood glucose readings but other readings as well. In some embodiments, by way of example, and without limitation, personal health data may include weight, body fat index, cholesterol levels, blood pressure levels, and number of miles run or walked within a time period.

The software module 105 generates an identification of an event responsive to the transmitted personal health data (312). In one embodiment, the software module 105 executes functionality substantially similar to the functionality described above in connection with FIGS. 1A-3B to generate the identification of the event for personal health data.

The software module 105 provides an application programming interface allowing an application provided by a second organization and executing on the mobile computing device, to access data associated with at least one of the personal health data and the identification of the event (314). In one embodiment, the software module 105 provides an interface such as the interface 107 described above in connection with FIGS. 1A-3B. In one embodiment, the application 109 displays a message on the mobile computing device 102, responsive to accessing the data associated with at least one of the personal health data and the identification of the event. In another embodiment, the application 109 transmits the data associated with at least one of the personal health data and the identification of the event to at least one of the second organization and a third organization. In some embodiments, the application 109 provides functionality for interacting with data associated with personal health data similar to the functionality described above in connection with FIGS. 1A-3B.

Referring back to FIG. 2, an embodiment is depicted in which the application 109 and the software module 105 are separate from each other and are provided by different organizations. However, in some embodiments, the application 109 and the software module 105 are separate from each other but provided by a single organization. For example, a first organization may provide the software module 105 and may create a customized application 109 for a second organization upon request. In other embodiments, the application 109 and the software module 105 are provided by different organization but are integrated to form a single component. For example, a first organization may provide the software module 105 to a second organization that embeds the software module 105 into an application 109 created by the second organization. In still other embodiments, the application 109 and the software module 105 are provided by a single organization and integrated to form a single component.

In some embodiments, a first organization may provide the software module 105 to a second organization that creates an application 109 including within it the entire software module 105. In other embodiments, however, the second organization may choose to selectively incorporate certain aspects of the software module, embedding only a sub-set of the functionality made available to the second organization within the application 109. In still other embodiments, the second organization may choose to receive data from the software module 105 via the application programming interface 107 and incorporate the data into the application 109—without incorporating the software module 105 or any of its subcomponents into the application 109.

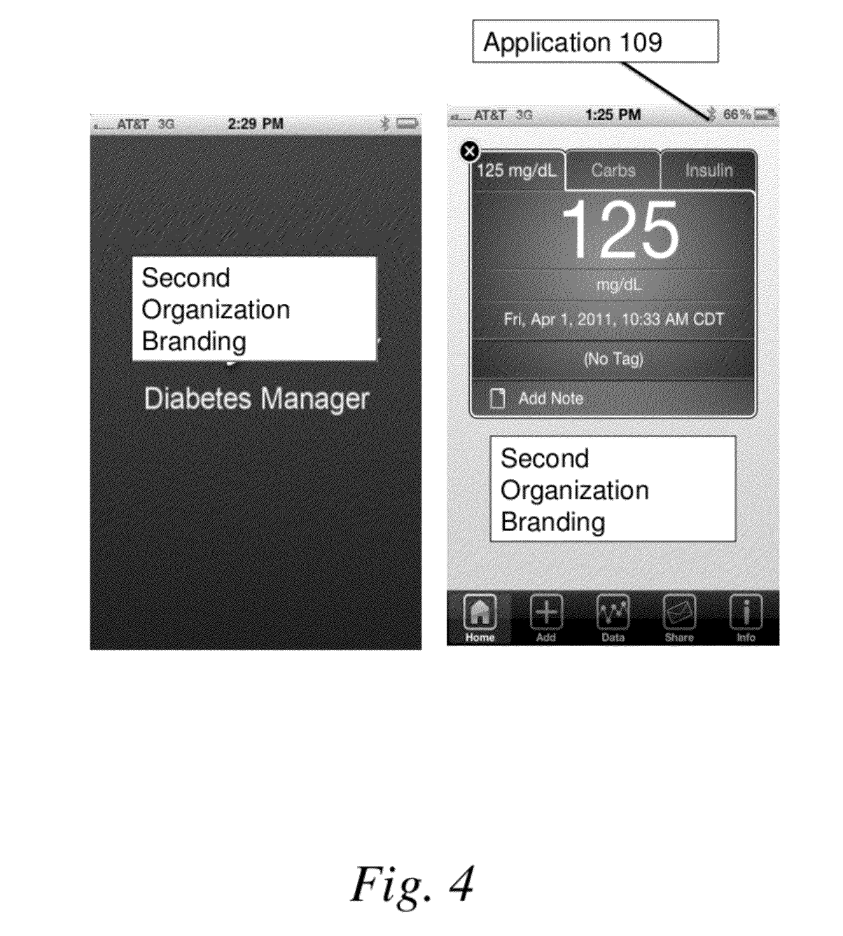

In some embodiments, how the software module 105 and the application 109 are integrated, if at all, impacts a regulatory categorization of one of the organizations. For example, a first organization may generate the software module 105 and an application 109 and receives required regulatory approval to distribute the software module 105 (e.g., from the Food and Drug Administration). Referring now to FIG. 4, a screen shot depicts an embodiment in which the first organization provides a customized application 109 to a second organization. In an embodiment in which the first organization creates a customized version of the application 109 for a second organization, the first organization may handle regulatory requirements such that the second organization may distribute the application 109 without having to seek separate regulatory approval (e.g., the first organization may file appropriate name change documentation with the FDA, listing the second organization instead of or in addition to itself).

In another embodiment, however, the second organization, receiving the customized application 109 from the first organization, may wish to further customize the application 109 in including additional data retrieved via the application programming interface 107. For example, the second organization may receive a white label version of the application 109, customized by the first organization with the organization's branding, and may choose to further customize the application 109 by including a display of a blood glucose reading retrieved via the application programming interface 107. In such an embodiment, although the first organization may handle some of the regulatory requirements (e.g., the first organization may file appropriate name change documentation with the FDA, listing the second organization instead of or in addition to itself), the second organization may have additional regulatory requirements with which to comply (e.g., requirements imposed on organizations providing Class I Medical Device Data Systems).

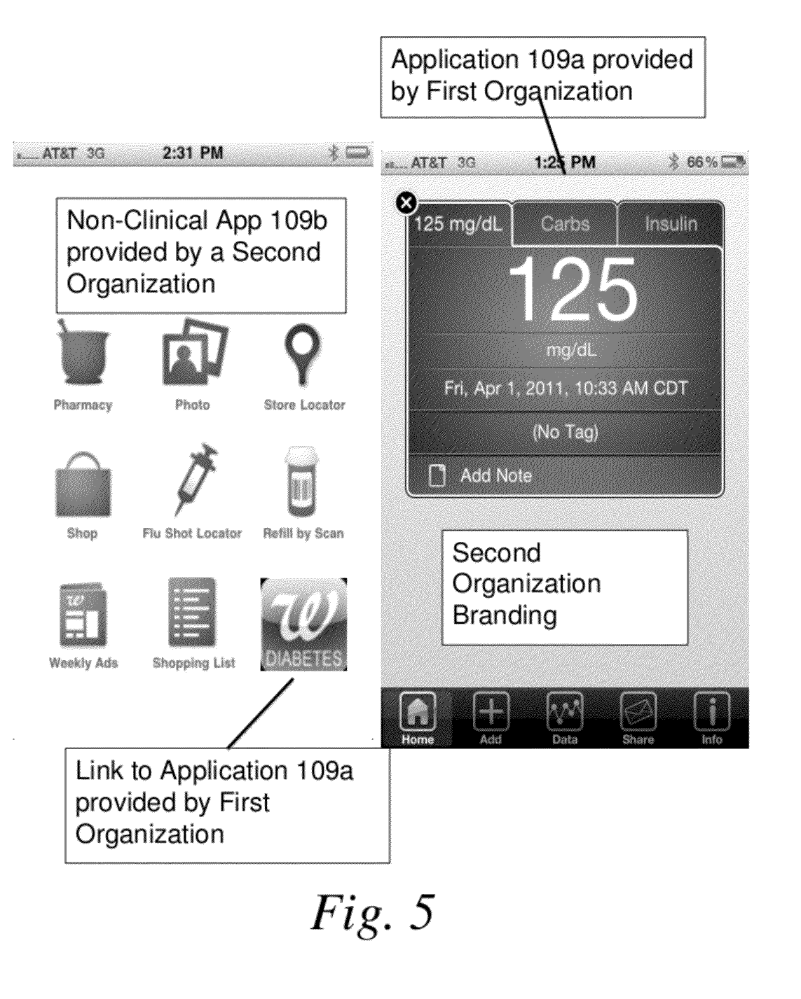

Referring now to FIG. 5, a screen shot depicts an embodiment in which the first organization generates an application 109a, provides a non-clinical application 109b into which the application 109 is incorporated. For example, the second organization may modify a previously provided non-clinical application 109b to include a link that executes the application 109a upon selection of the link by a user of the non-clinical application 109b. As another example, the second organization may modify the non-clinical application 109b so that the application 109 appears to a user of the non-clinical application 109b to be a widget embedded within the non-clinical application 109b. In this embodiment, the first organization may handle regulatory requirements such that the second organization may distribute the application 109 without having to seek separate regulatory approval (e.g., the first organization may file appropriate name change documentation with the FDA, listing the second organization instead of or in addition to itself).

In one embodiment, in addition to embedding the application 109a (provided by the first organization) into a modified version of the non-clinical application 109b, the second organization may choose to integrate data accessed via the application programming interface 107 into the non-clinical application 109b. For example, the second organization may provide a non-clinical application 109b that provides users with retail functionality—purchasing items from the second organization—and may then incorporate the application 109a provided by the first organization such that a user can execute application 109a from within an execution of non-clinical application 109b; in addition to this, the second organization may modify the non-clinical application 109b to display data retrieved via the application programming interface 107 by displaying, for example and without limitation, a blood glucose reading within a user interface displayed to the user of the non-clinical application 109b. In such an embodiment, the second organization may have regulatory requirements with which to comply (e.g., requirements imposed on organizations providing Class I Medical Device Data Systems), separate from any requirements imposed upon the first organization.

In another embodiment, instead of embedding the application 109a of the first organization into its own non-clinical application 109b, the second organization chooses to integrate data accessed via the application programming interface 107 into the non-clinical application 109b. For example, the second organization may provide a non-clinical application 109b that provides users with retail functionality—purchasing items from the second organization—and may then modify the non-clinical application 109b to display data retrieved via the application programming interface 107 by displaying, for example and without limitation, a blood glucose reading within a user interface displayed to the user of the non-clinical application 109b, without embedding an application 109 into the non-clinical application 109b. In such an embodiment, the second organization may have regulatory requirements with which to comply (e.g., requirements imposed on organizations providing Class I Medical Device Data Systems), separate from any requirements imposed upon the first organization.

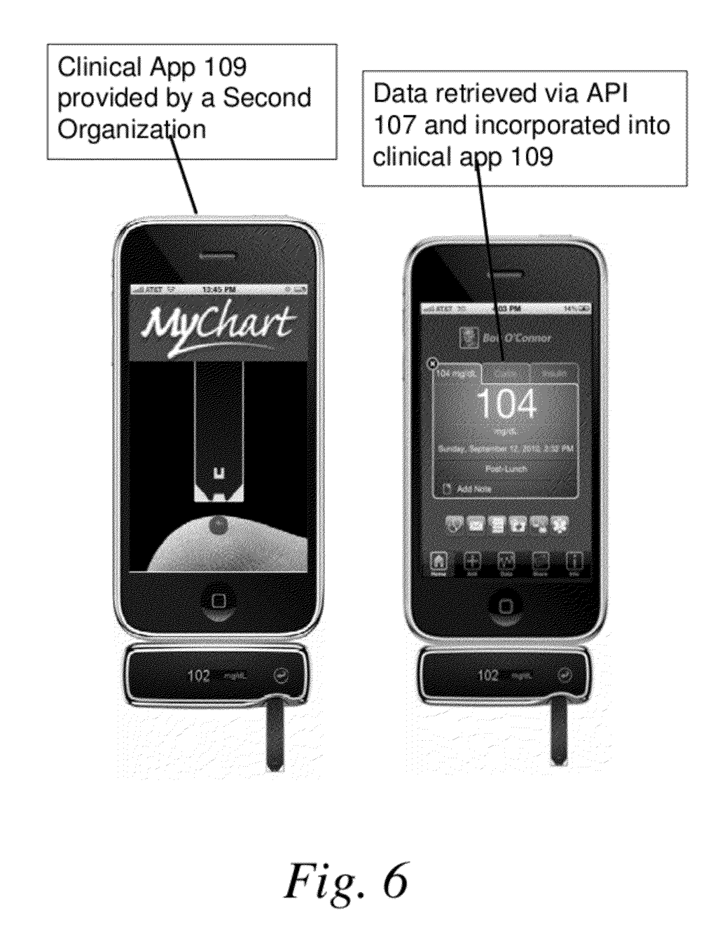

Referring now to FIG. 6, a screen shot depicts an embodiment in which the second organization provides a clinical application that incorporates data retrieved via the application programming interface 109 (e.g., blood glucose readings or user interface elements). In this embodiment, the second organization may be considered to be distributing a Class II medical device and may have regulatory requirements with which to comply, separate from any requirements with which the first organization complied.

In one embodiment, a first organization implements the software module 105 and the application programming interface 107 and allows a second organization to select a level of customization that will result in a regulatory path acceptable to the second organization. For example, the second organization may choose to leave all of the implementation details to the first organization and simply accept a private label version of the application in order to minimize regulatory requirements with which it must comply—while a third organization may determine that satisfying a more rigorous regulatory path is worth the effort in order to exercise a high degree of control over the application and/or to access data via the application programming interface 107. In some embodiments of the methods and systems described herein, offer a highly customizable approach with which organizations may interact to select a highly customized level of functionality and control over data, as well as favorable regulatory paths.

It should be understood that the systems described above may provide multiple ones of any or each of those components and these components may be provided on either a standalone machine or, in some embodiments, on multiple machines in a distributed system.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for enabling applications on a mobile computing device to access data associated with a peripheral medical device, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for enabling an application executing on a mobile computing device to access, via an application programming interface, data associated with a measurement taken by a blood glucose meter peripheral to the mobile computing device, the method comprising:
transmitting, by a blood glucose meter peripherally connected to a mobile computing device, to a software module provided by a first organization and executing on the mobile computing device, a blood glucose reading of a user of the blood glucose meter;
generating, by the software module, an identification of an event responsive to the transmitted blood glucose reading; and
providing, by the software module, an application programming interface allowing an application provided by a second organization and executing on the mobile computing device, to access data associated with at least one of the blood glucose reading and the identification of the event.

2. The method of claim 1 further comprising accessing, by the application, the data associated with at least one of the blood glucose reading and the identification of the event.

3. The method of claim 1 further comprising displaying, by the application, a message on the mobile computing device, responsive to accessing the data associated with at least one of the blood glucose reading and the identification of the event.

4. The method of claim 1 further comprising transmitting the data associated with at least one of the blood glucose reading and the identification of the event, by the application executing on the mobile computing device, to at least one of the second organization and a third organization.

5. The method of claim 1 further comprising receiving, by the software module, from the blood glucose meter, data associated with the blood glucose meter.

6. The method of claim 1 further comprising receiving, by the software module, from the blood glucose meter, data associated with a test strip used in conjunction with the blood glucose meter.

7. The method of claim 1 further comprising receiving, by the software module, from the blood glucose meter, a plurality of blood glucose readings of the user of the blood glucose meter.

8. The method of claim 1 further comprising performing, by the software module, an analysis on data including the transmitted blood glucose reading.

9. The method of claim 1 further comprising transmitting, by the software module, to the application, a result of an analysis of a data set including the transmitted blood glucose reading.

10. A system for enabling an application executing on a mobile computing device to access, via an application programming interface, data associated with a measurement taken by a blood glucose meter peripheral to the mobile computing device, comprising:
a blood glucose meter peripherally connected to a mobile computing device;
a software module provided by a first organization: i) executing on the mobile computing device, ii) receiving, from the blood glucose meter, a blood glucose reading, and iii) generating an identification of an event responsive to the received blood glucose reading; and
an application provided by a second organization, executing on the mobile computing device and accessing, via the application programming interface provided by the software module, data associated with at least one of the blood glucose reading and the identification of the event.

11. The system of claim 10, wherein the software module further comprises a module analyzing data including the transmitted blood glucose reading.

12. The system of claim 10, wherein the software module further comprises a module generating a user interface for display by the application to a user of the mobile computing device.

13. The system of claim 10, wherein the software module further comprises a module storing the transmitted blood glucose reading on the mobile computing device.

14. The system of claim 10, wherein the software module executes from within the application provided by the second organization.

15. The system of claim 10, wherein the application further comprises a reminder generation module.

16. The system of claim 10, wherein the application further comprises a decision support module.

17. The system of claim 10, wherein the application further comprises a communications module for exchanging data with at least one remote system.

18. The system of claim 10, wherein the application further comprises a personal health logbook.

19. A method for enabling an application executing on a mobile computing device to access, via an application programming interface, data associated with a measurement taken by a medical device peripheral to the mobile computing device, the method comprising:
transmitting, by a medical device peripherally connected to a mobile computing device, to a software module provided by a first organization and executing on the mobile computing device, personal health data of a user of the medical device;
generating, by the software module, an identification of an event responsive to the transmitted personal health data; and
providing, by the software module, an application programming interface allowing an application provided by a second organization and executing on the mobile computing device, to access data associated with at least one of the personal health data and the identification of the event.

20. The method of claim 19 further comprising displaying, by the application, a message on the mobile computing device, responsive to accessing the data associated with at least one of the personal health data and the identification of the event.

21. The method of claim 19 further comprising transmitting the data associated with at least one of the personal health data and the identification of the event, by the application executing on the mobile computing device, to at least one of the second organization and a third organization.
